(19) United States
(12) Patent Application Publication
(10) Pub. No.: US 2007/0028463 A1
(43) Pub. Date: Feb. 8, 2007

(54) Paper cutter

(76) Inventor: Stephen Kwok Ki Chan, Kwai Chung (HK)

Correspondence Address: LEYDIG VOIT & MAYER, LTD, 700 THIRTEENTH ST. NW, SUITE 300, WASHINGTON, DC, 20005-3960, US

(21) Appl. No.: 11/194,451

(22) Filed: Aug. 2, 2005

(51) Int. Cl. B26B 3/00

(52) U.S. Cl. 30/319

(57) ABSTRACT

Paper-cutting apparatus includes a carriage for sliding along a guide, a cassette holder, and a cassette encasing a blade and interacting with the carriage, when mounted to the cassette holder, to expose a portion of the blade during attachment of the cassette holder to the carriage.

### BACKGROUND OF THE INVENTION

The present invention relates to paper cutters or “line cutters” of the type comprising a cutting board and a guide or “ruler” slidably mounted at its ends to be repositionable over a sheet of paper on the board allowing a carriage-mounted blade upon the ruler to be moved therealong to cut a line in the sheet of paper. More particularly, although not exclusively, the invention relates to a paper cutter carriage having a wheeled blade cassette with a special safety cover that protects the user from the blade prior to installation upon the line cutter.

Paper cutters of the type described above comprise replaceable blades that are purchased separately or come with a kit of blades and perforation disks. Replacement of the blade is a dangerous exercise that can result in finger cut injury.

### OBJECTS OF THE INVENTION

It is an object of the present invention to overcome or substantially ameliorate the above disadvantage and/or more generally to provide an improved paper-cutting carriage and safety blade cassette.

### SUMMARY OF THE INVENTION

According to the invention, there is provided a paper-cutting apparatus, comprising:
a carriage for sliding along a guide,
a cassette holder, and
a cassette encasing a blade and interacting with the carriage when mounted to the cassette holder to expose a portion of the blade during attachment of the cassette holder to the carriage.

Preferably, the carriage comprises a ramp and the cassette comprises a first blade cover that engages the ramp during said attachment to expose one side of said portion of the blade.

Preferably, the carriage includes a capture lug, and the cassette holder includes a cassette-receiving cradle having a capture tab, the cassette holder further comprising a locking mechanism which upon activation moves the carriage so that its capture tab is capture behind the capture lug of the carriage to thereby retaining the cassette holder.

Preferably, the cassette comprises a second blade cover which moves with the cradle to expose the other side of said portion of the blade.

Preferably, the locking mechanism comprises a knob and a cam which upon turning of the knob engages a cam follower of the cradle to effect movement of the cradle.

Preferably, the carriage comprises. an axle-support aperture, and the cassette holder comprises an axle that extends through the cassette into the axle-support aperture of the carriage.

Preferably, the cassette further comprises a positioning lug, and wherein the cradle comprises a positioning recess for receiving the positioning lug.

Preferably, the blade is circular, having a bushing at its centre through which the axle passes.

Preferably, the cassette comprises a plurality of chassis pins connecting a pair of opposed retaining plates between which the first and second blade covers reside, each of the blade covers having a corresponding plurality of guide slots through which the chassis pins extend.

Preferably, the apparatus further comprises a chassis plate through which the bushing passes for support thereby, and wherein the second blade cover comprises a spring support, and wherein a spring extends between the spring support and the chassis plate.

Preferably, the apparatus further comprises a release plate alongside the chassis plate having a resilient release bar extending therefrom and wherein the second blade cover plate includes a catch with which the release bar extends, the second cover plate further comprising an aperture adjacent to the release bar, the cassette holder comprising a pusher that extends through the aperture to engage the release bar and deflect it away from the catch so that the second blade cover can move relative to the chassis plate when the cassette is attached to the cassette holder.

Preferably, the cassette holder comprises a latch bar projecting therefrom, and wherein the cassette comprises a spring-biased pawl engaging a pawl catch, the latch bar bearing against the pawl when the cassette is installed upon the cassette holder to release the pawl from the pawl catch to thereby enable the first blade cover to move relative to the second blade cover.

There is further disclosed herein a cassette for use with a line cutter comprising a carriage and a cassette holder, the cassette encasing a blade for interaction with the cassette holder to expose a portion of the blade during attachment of the cassette thereto.

Preferably, the cassette further comprises a second blade cover for movement to expose the other side of said portion of the blade.

Preferably, the cassette further comprises a positioning lug, for receipt within a positioning recess in a cradle of a cassette holder.

Preferably, the blade is circular, having a bushing at its centre through which an axle passes.

Preferably, the cassette further comprises a plurality of chassis pins connecting a pair of opposed retaining plates between which the first and second blade covers reside, each of the blade covers having a corresponding plurality of guide slots through which the chassis pins extend.

Preferably, the cassette further comprises a chassis plate through which the bushing passes for support thereby, and wherein the second blade cover comprises a spring support, and wherein a spring extends between the spring support and the chassis plate.

Preferably, the cassette further comprises a release plate alongside the chassis plate having a resilient release bar extending therefrom and wherein the second blade cover plate includes a catch with which the release bar interacts, the second cover plate further comprising an aperture adjacent to the release bar, the release bar adapted to interact with a pusher of a cassette holder that extends through the aperture to engage the release bar and deflect it away from the catch so that the second blade cover can move relative to the chassis plate when the cassette is attached to the cassette holder.

Preferably, the cassette further comprises a spring-biased pawl engaging a pawl catch, wherein the cassette holder comprises a latch bar projecting therefrom, and the latch bar bears against the pawl when the cassette is installed upon the cassette holder to release the pawl from the pawl catch to thereby enable the first blade cover to move relative to the second blade cover.

### BRIEF DESCRIPTION OF DRAWINGS

The invention will now be more particularly described, by way of example only, with reference to the accompanying drawings, in which:

FIG. 1 is schematic rear perspective illustration of a cassette holder and blade cassette;

FIG. 2 is a schematic parts-exploded perspective illustration of the cassette holder of FIG. 1 and a carriage for linear motion along a ruler;

FIG. 3 is a schematic perspective illustration of the parts shown in FIG. 2;

FIG. 4 is a schematic front elevation of the parts shown in FIG. 2, showing a locking knob in an unlocked orientation;

FIG. 5 is a schematic cross-sectional side elevation taken at A1-A1 in FIG. 4;

FIG. 6 is a schematic cross-sectional side elevation taken at A-A in FIG. 4;

FIG. 7 is a schematic front elevation of the parts shown in FIG. 2, showing a locking knob in a locked orientation;

FIG. 8 is a schematic cross-sectional side elevation taken at B1-B1 in FIG. 7;

FIG. 9 is a schematic cross-sectional side elevation taken at B-B in FIG. 7;

FIG. 10 is a schematic cross-sectional plan taken at B2-B2 in FIG. 7;

FIG. 11 is a schematic parts-exploded perspective illustration of the cassette holder, a cradle, the cassette and the carriage;

FIG. 12 is a schematic perspective illustration of the carriage and cassette;

FIG. 13 is a schematic partially cutaway perspective illustration of the carriage and cassette;

FIG. 14 is a schematic cross-sectional side elevation of the carriage and cassette;

FIG. 15 is a schematic perspective illustration of the parts shown in FIG. A 13, but also depicting the cassette cradle in phantom line;

FIG. 16 is a schematic elevation showing internal parts of the cassette in a locked-in state;

FIG. 17 is a schematic elevation showing internal parts of the cassette in an unlocked state;

FIG. 18 is a schematic elevation showing internal parts of the cassette in an unlocking state;

FIG. 19 is a schematic parts-exploded perspective illustration of the cassette;

FIG. 20 is a schematic parts-exploded rear perspective illustration of the cassette;

FIG. 21 is a schematic perspective illustration of the cassette in motion across the sheet of paper in use;

FIG. 22 is a schematic partially cutaway perspective illustration of the cassette with its blade completely encased thereby;

FIG. 23 is a schematic partially cut-away perspective illustration of the cassette with one of its covers raised to partially expose a portion of the blade;

FIG. 24 is a schematic partially cut-away perspective illustration of the cassette with both its covers raised to expose a portion of the blade;

FIG. 25 is a schematic cross-sectional elevation of the cassette in the configuration of FIG. 22;

FIG. 26 is a schematic cross-sectional elevation of the cassette in the configuration of FIG. 23;

FIG. 27 is a schematic cross-sectional elevation of the cassette in the configuration of FIG. 24;

FIG. 28 is a schematic partial rear perspective illustration of internal components of the cassette and the cassette holder in phantom line;

FIG. 29 is a schematic rear perspective illustration of the cassette;

FIG. 30 is a schematic cross-sectional side elevation of the cassette and cassette holder showing an internal pawl release bar in a non-deflected state;

FIG. 31 is a schematic cross-sectional side elevation of the cassette and cassette holder showing the internal pawl release bar in a partially deflected state;

FIG. 32 is a schematic cross-sectional side elevation of the cassette and cassette holder showing the internal pawl release bar in a fully deflected state with its second cover raised upon turning the knob;

FIG. 33 is a schematic front elevation of the parts shown in the FIG. 31 configuration; and

FIG. 34 is a schematic front elevation of the parts shown in the FIG. 32 configuration.

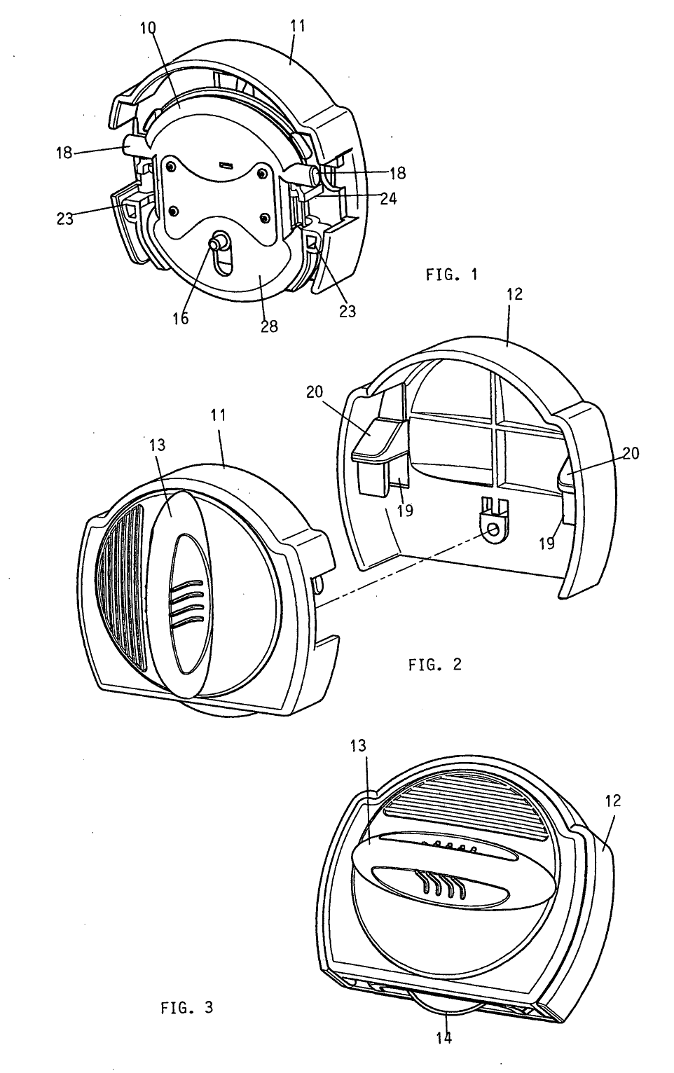

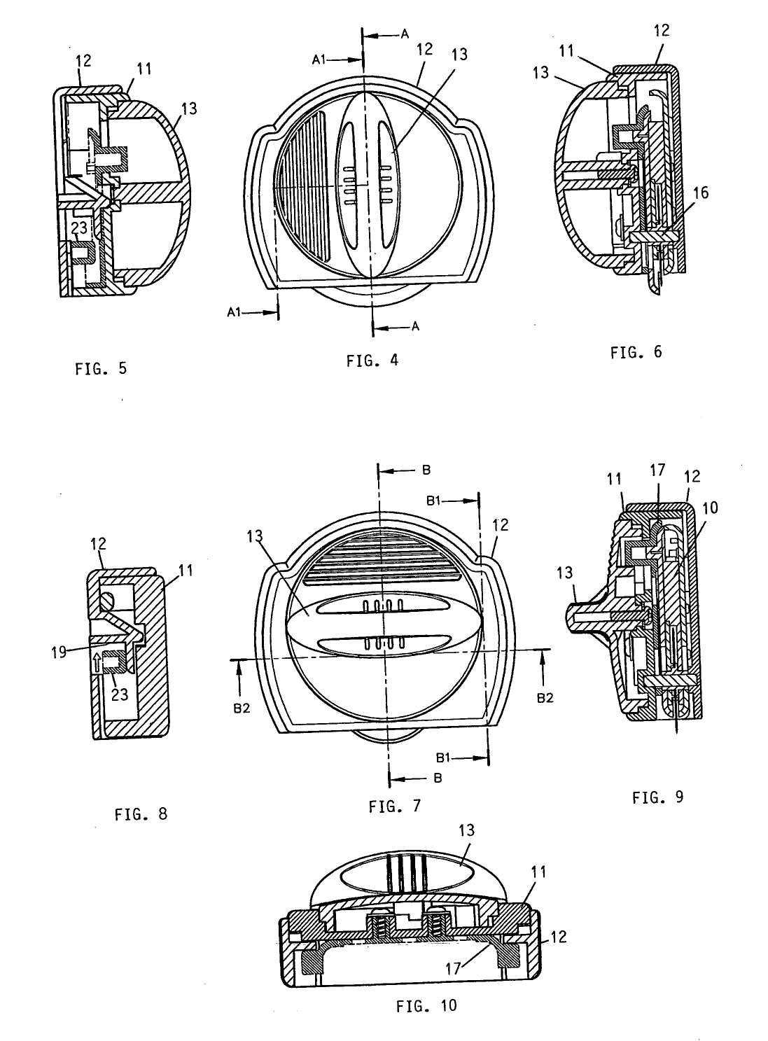

### DETAILED DESCRIPTION OF PREFERRED EMBODIMENT

Referring to the drawings, there is shown a paper cutting apparatus embodying the invention, which comprises a replaceable cassette 10 and a cassette holder 11 for mounting upon a carriage 12 that would slide along a track (not shown). The track would be part of the “ruler” that would be positioned upon/attached to a cutting board in use.

The cassette holder 11 has a first blade cover 28 with a pair of ears 18 extending oppositely from it. An axle 16 extends from the cassette holder and passes through the cassette 10 when it is mounted.

The cassette holder 11 has attached to its inside surface a moving cassette-support cradle 17 which includes a pair of capture tabs 23. The carriage 12 has the a pair of internal ramps 20 against which the ears 18 ride to move the first blade cover 28 in the direction of the arrow of FIG. 13 when the cassette and cassette holder are mounted in the carriage. The capture tabs 23 are secured behind the capture lugs 19 upon turning of a knob 13 when the cassette holder and cassette are mounted to the carriage. A 90 degree turn of the knob 13 moves the carriage and also the cassette linearly.

There is a circular cutting blade or perforation wheel 14 within the cassette 10, having a central aperture through which the axle 14 passes when the cassette is mounted to the cassette holder. The carriage includes an axle-support aperture 40 into which the tip of the axle enters when the cassette holder is installed in the carriage.

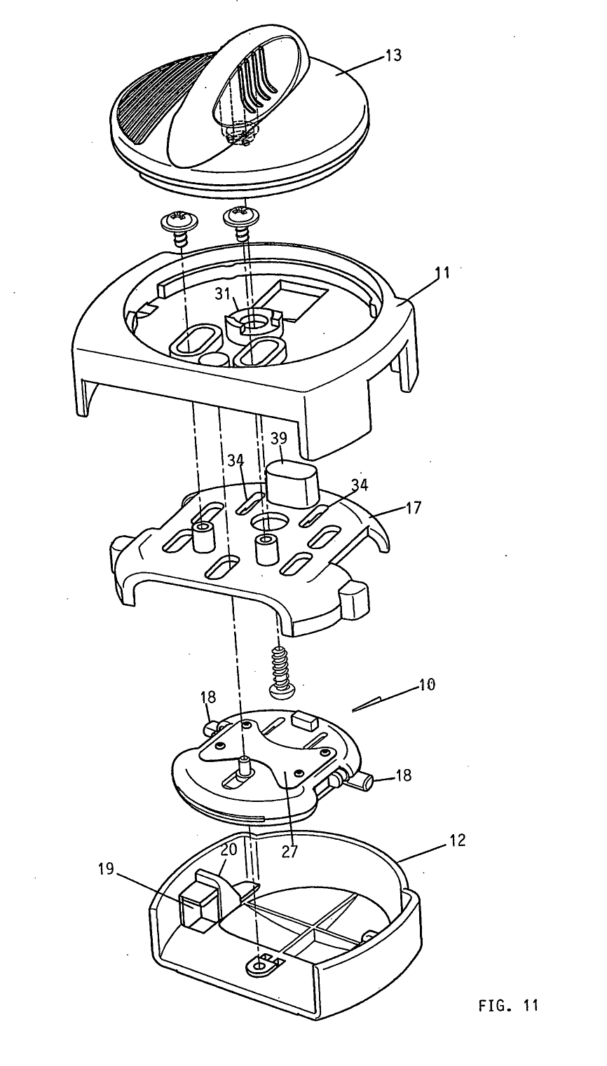

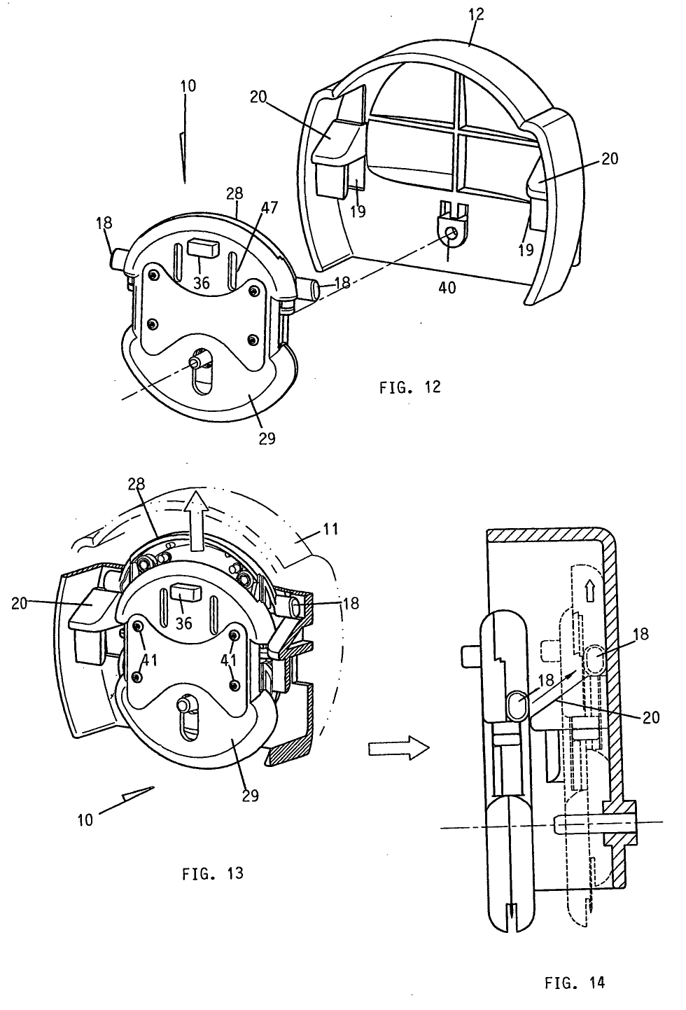

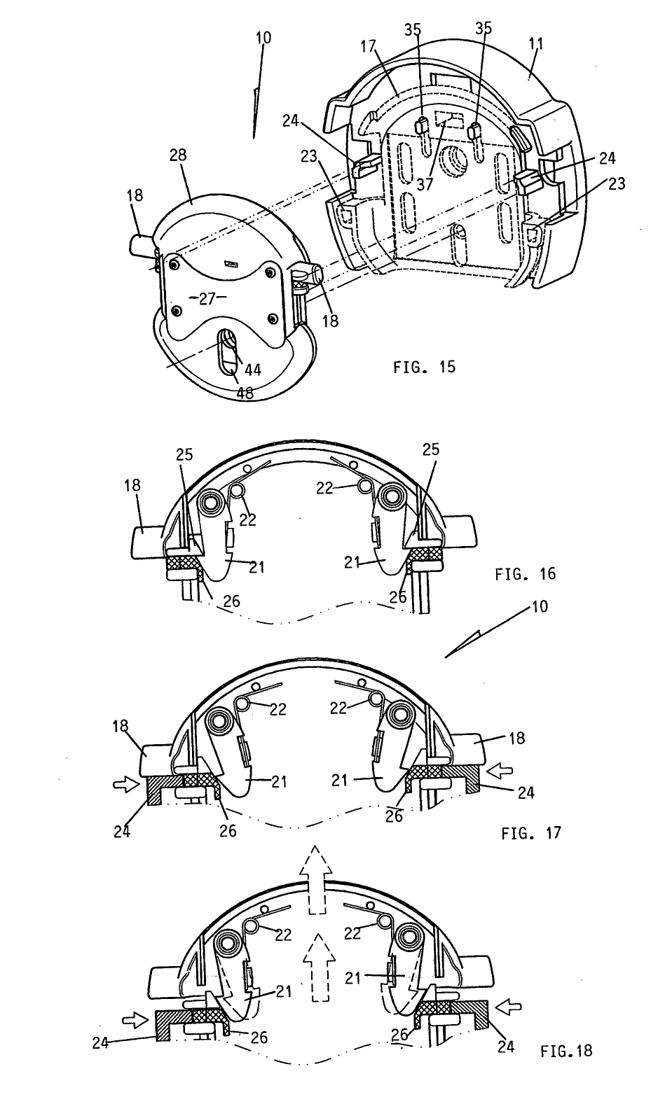

The knob 13 is mounted upon the cassette holder 11 in a pivotal manner having its range of pivoting limited by a spindle 31 as shown in FIG. 11. The cassette cradle 17 includes a cam follower 39 that is acted upon by a cam 38 that is attached to the knob 13. As shown in FIG. 11, the cradle 17 is screw-fixed to the cassette holder 11 in a manner enabling linear sliding movement.

The cassette includes on its second blade cover 29 a positioning lug 36 that fits into a positioning lug recess 37 of the cradle 17.

A pair of pushers 35 extends from the cassette holder through slots in the cradle nearby the positioning lug recess 37.

Also extending from the cassette holder 11 is a pair of latch bars 24.

Apart from the blade itself, the above parts are typically of moulded plastics material.

The cassette itself comprises a pair of metallic retaining plates 27 connected to the cassette by a quad of chassis pins 41.

Mounted internally of the first blade cover 28 is a pair of pawls 21. Each of these is mounted pivotally and biased away from one another by means of a pair of torsion springs 22 as shown in FIG. 16. The pawls 21 catch upon pawl catches 25 to prevent sliding movement of the blade covers with respect to one another unless the cassette is installed upon the cassette holder 11. When so installed, release bars 26 which engage with the tips of the pawls 21 are forced inwardly by interaction with the latch bars 24 against the spring force exerted by torsion springs 22.

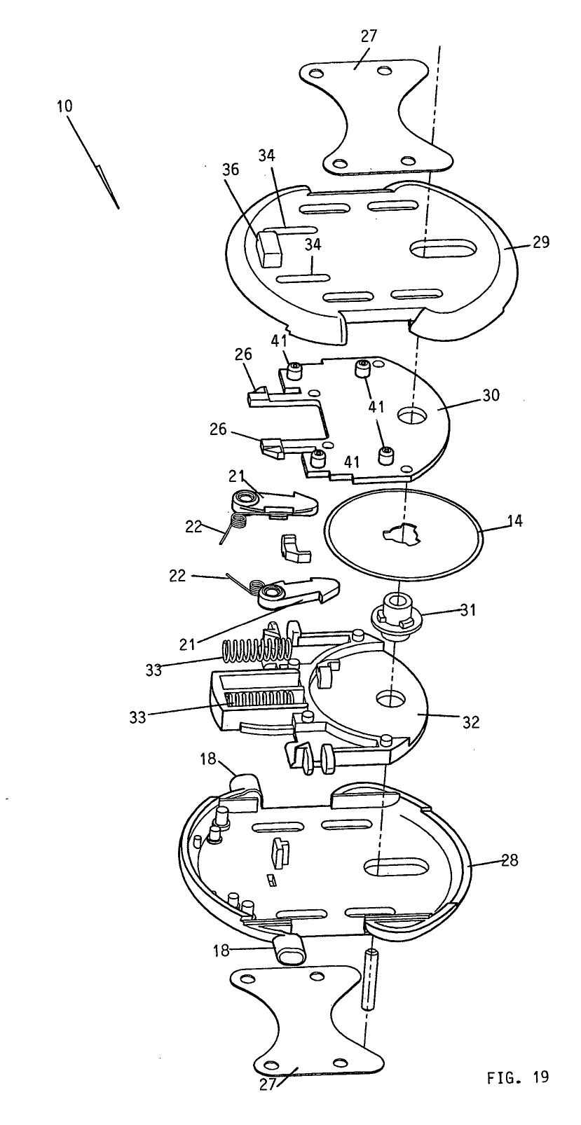

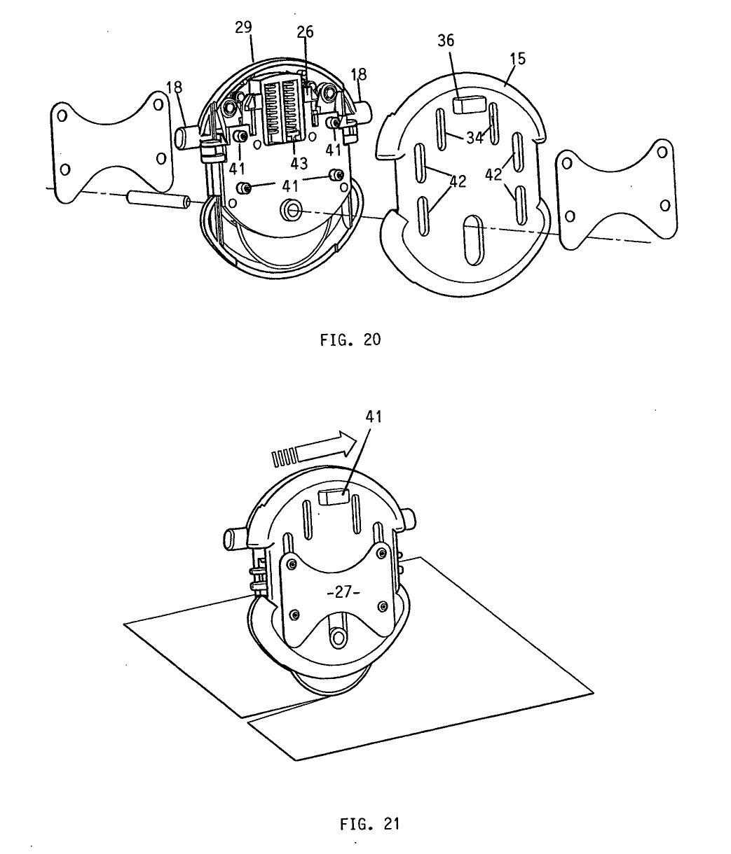

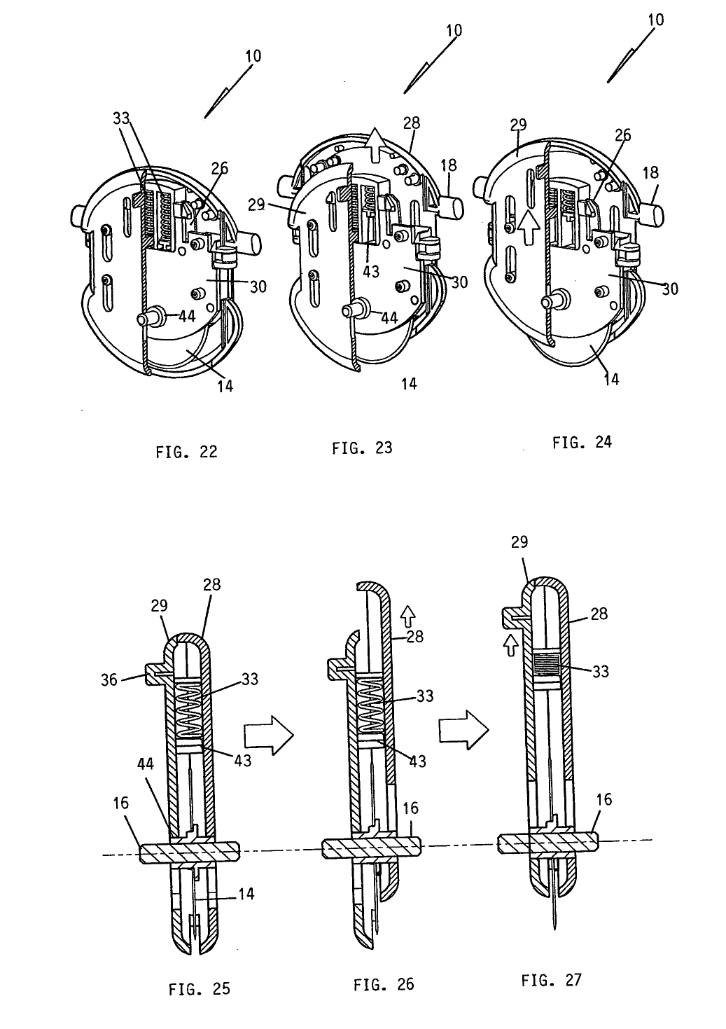

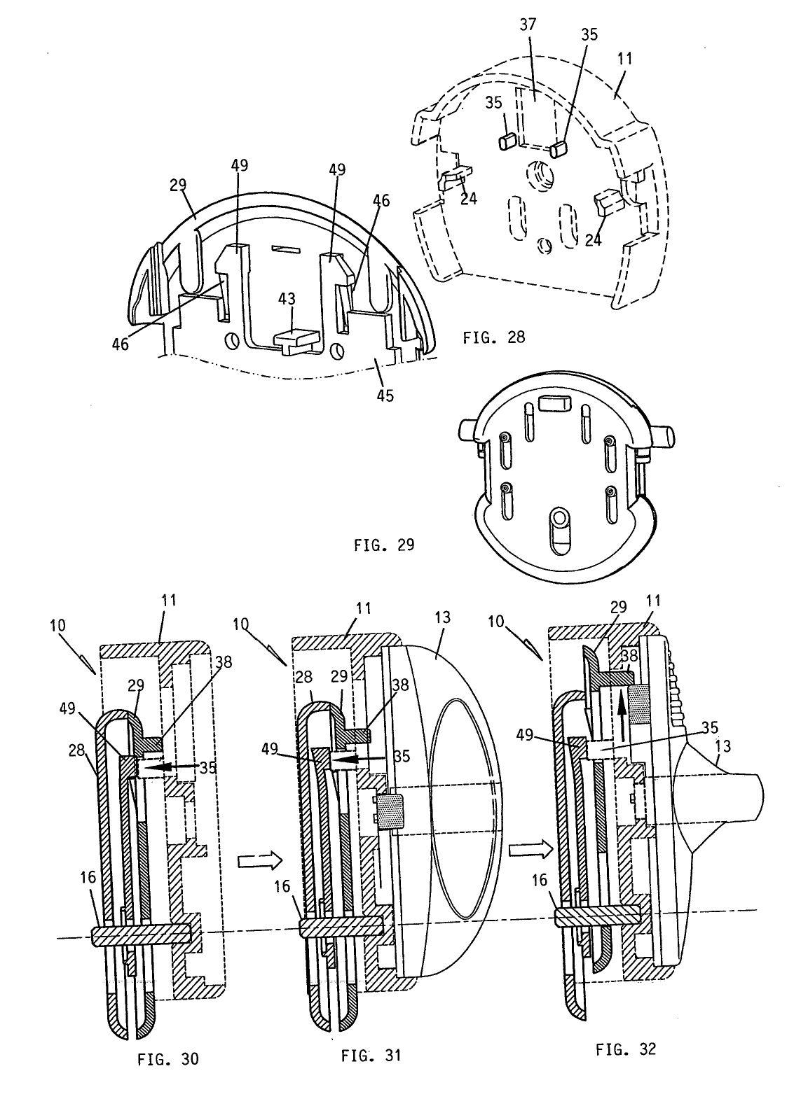

As shown in FIG. 19, an un-latching plate 30, positioned between the blade cover plates, integrally includes the chassis pins 41. These chassis pins extend through the guide slots 42 in the second blade cover 29 and have their tips melted onto the top retaining plate 27. The bottom retaining plate 27 is mounted on similar chassis pins which extend from the first blade cover 28.

A spring plate 32 includes an extension frame within which a pair of coil springs 33 is located. These coil springs bear against respective spring supports 43 that extend inwardly from the first cover 28 and serve to bias the second blade cover 29 downwardly.

The blade 14 has at its centre a bushing 44 that can move within a slot 48 of the first blade cover 28 when that over moves. The bushing is fixed to the blade and spins with respect to the un-latching plate 30.

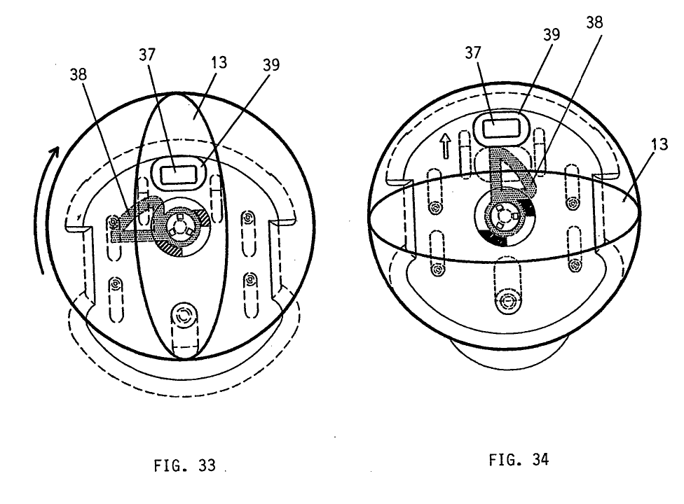

The second blade cover 29 includes a pair of ramp-shaped catches 46 over which a leaf spring of the release plate 45 rides. The release plate 45, which moves with respect to the second blade cover 29, has an aperture through which the axle 16 passes so as to move with the blade 14. The pushers 35 bear against the leaf springs 49 when the cassette is installed upon the cassette holder 11 so as to release the leaf springs from the catches as shown in FIGS. 30 to 32. This enables the second blade cover 29 to move upwardly with respect to the first blade cover upon turning of the knob 13.

The present invention provides a very safe replacement blade cassette in which the blade covers cannot readily be moved to expose the blade unless the cassette is both installed upon the cassette holder and the cassette holder is in turn installed upon the carriage and the knob turned. Upon insertion of the cassette holder to the carriage, the first blade cover is automatically raised to expose one side of a cutting portion of the blade. Upon turning of the knob, the second blade cover is raised to expose the other side of the cutting portion of the blade and the cassette holder is thereby retained upon the carriage.

The invention has been given by way of example only, and various other modifications of and/or alterations to the described embodiment may be made by persons skilled in the art without departing from the scope of the invention as specified in the appended claims.

1. Paper-cutting apparatus comprising:
a carriage for sliding along a guide,
a cassette holder, and
a cassette encasing a blade and interacting with the carriages when mounted to the cassette holder, to expose a portion of the blade during attachment of the cassette holder to the carriage.

2. The apparatus of claim 1, wherein the carriage comprises a ramp and the cassette comprises a first blade cover that engages the ramp during the attachment to expose a first side of the portion of the blade.

3. The apparatus of claim 2, wherein the carriage includes a capture lug, and the cassette holder includes a cassette-receiving cradle having a capture tab, the cassette holder further comprising a locking mechanism which, upon activation, moves the carriage so that the capture tab is captured behind the capture lug of the carriage to retain the cassette holder.

4. The apparatus of claim 3, wherein the cassette comprises a second blade cover which moves with the cradle to expose a second side of the portion of the blade.

5. The apparatus of claim 3, wherein the locking mechanism comprises a knob and a cam which, upon turning of the knob, engages a cam follower of the cradle to effect movement of the cradle.

6. The apparatus of claim 3, wherein the carriage comprises an axle-support aperture, and the cassette holder comprises an axle that extends through the cassette into the axle-support aperture of the carriage.

7. The apparatus of claim 3, wherein
the cassette further comprises a positioning lug, and
the cradle comprises a positioning recess for receiving the positioning lug.

8. The apparatus of claim 6, wherein the blade is circular, and has a centrally located bushing through which the axle passes.

9. The apparatus of claim 8, wherein the cassette comprises a plurality of chassis pins connecting a pair of opposed retaining plates between which the first and second blade covers reside, each of the first and second blade covers having a corresponding plurality of guide slots through which the chassis pins extend.

10. The apparatus of claim 9, further comprising a chassis plate through which the bushing passes for support, and wherein
the second blade cover comprises a spring support, and
a spring extends between the spring support and the chassis plate.

11. The apparatus of claim 10, further comprising a release plate, alongside the chassis plate, having an extending resilient release bar and wherein
the second blade cover plate includes a catch with which the release bar extends,
the second cover plate further comprises an aperture adjacent to the release bar, and
the cassette holder comprises a pusher that extends through the aperture to engage the release bar and deflect the release bar away from the catch so that the second blade cover can move relative to the chassis plate when the cassette is attached to the cassette holder.

12. The apparatus of claim 2, wherein
the cassette holder comprises a projecting latch bar, and
the cassette comprises a spring-biased pawl engaging a pawl catch, the latch bar bearing against the pawl, when the cassette is installed upon the cassette holder, to release the pawl from the pawl catch and enable the first blade cover to move relative to the second blade cover.

13. A cassette for use with a line cutter comprising a carriage and a cassette holder, the cassette including a first blade cover and encasing a blade for interaction with the cassette holder to expose a first side of a portion of the blade during attachment of the cassette to the carriage.

14. The cassette of claim 13, further comprising a second blade cover for movement to expose a second side of the portion of the blade.

15. The cassette of claim 13, further comprising a positioning lug, for receipt within a positioning recess in a cradle of a cassette holder.

16. The cassette of claim 14, wherein the blade is circular and has a centrally located bushing through which an axle passes.

17. The cassette of claim 16, further comprising a plurality of chassis pins connecting a pair of opposed retaining plates between which the first and second blade covers reside, each of the first and second blade covers having a corresponding plurality of guide slots through which the chassis pins extend.

18. The cassette of claim 17, further comprising a chassis plate through which the bushing passes for support, and wherein
the second blade cover comprises a spring support, and
spring extends between the spring support and the chassis plate.

19. The cassette of claim 18, further comprising a release plates, alongside the chassis plate, having an extending resilient release bar and wherein
the second blade cover plate includes a catch with which the release bar interacts,
the second cover plate further comprises an aperture adjacent to the release bar, and
the release bar interacts with a pusher of a cassette holder that extends through the aperture to engage the release bar and deflect the release bar away from the catch so that the second blade cover can move relative to the chassis plate when the cassette is attached to the cassette holder.

20. The cassette of claim 14, wherein
the cassette comprises a spring-biased pawl engaging a pawl catch,
the cassette holder comprises a projecting latch bar, and
the latch bar bears against the pawl when the cassette is installed upon the cassette holder to release the pawl from the pawl catch and enable the first blade cover to move relative to the second blade cover.
